(19) United States
(12) Patent Application Publication
(10) Pub. No.: US 2004/0031658 A1
(43) Pub. Date: Feb. 19, 2004

(54) Magnetic clutch assembly and oil and gas burner with such assembly

(76) Inventor: Kenneth J. Kasper, Baldwin, NY (US)

Correspondence Address: Steven Horowitz, Counselor At Law, Suite 700, 295 Madison Avenue, New York, NY, 10017, US

(21) Appl. No.: 10/218,367

(22) Filed: Aug. 14, 2002

(51) Int. Cl. F16D 11/04

(52) U.S. Cl. 192/70.11; 192/84.1

(57) ABSTRACT

Magnetic clutch assembly for use in a hybrid oil and gas burner and a hybrid oil and gas burner that incorporates such an assembly. The magnetic clutch assembly is between the fan motor and the oil pump in order to selectively operate the oil pump and thereby prevent any oil fuel from circulating during gas mode. The assembly includes a magnetic clutch having an electromagnet and a magnetic clutch shaft for coupling the magnetic clutch assembly to a shaft of the fan motor, an inner clutch plate that fits on a shaft of the oil pump, an outer clutch plate, and a magnetic clutch housing for securely placing the assembly between oil pump and fan motor. When the burner is switched to oil mode the magnetic clutch assembly engages the oil pump and in gas mode it disengages the oil pump. Oil pump breakdown and oil fire danger are reduced.

The field of this invention is magnetic clutch assemblies and hybrid oil and gas burners, particularly those that are for commercial use.

### BACKGROUND OF THE INVENTION AND DISCUSSION OF THE PRIOR ART

Heating of non-residential buildings is typically by means of gas heat or oil heat. Both of these heating systems make use of a burner. Nowadays, due to the fact that the price of oil fluctuates so significantly relative to gas, it is desirable and very common in commercial office buildings and other structures to have a combination oil and gas combination burner. During periods of high oil prices, the utility company often offers the owners of commercial buildings heated by combination oil and gas burners a significant discount, such as twenty per cent, to switch to oil fuel when the temperature outside reaches a certain temperature, for example 20 degrees Fahrenheit. Then, later when the temperature rises again and the discount no longer applies, or if the price of oil declines significantly relative to gas, it may be significantly cheaper to use gas fuel in the burner. So the building owner switches back to gas fuel. There are in fact times when a directive to the building owner to switch from one fuel to another is given suddenly and the law or a pre-existing agreement exacts a significant monetary penalty for not switching to the particular fuel, say oil, within an allotted time period, say forty-eight hours.

Due to the fact that it is often necessary to immediately switch from one fuel to another—having the burner burn gas fuel instead of having it burn oil fuel or vice versa, it is of critical importance that the portion of the combination oil and gas burner devoted to the burning of oil fuel be in perfect condition even during those periods of time in which the burner is burning gas fuel. Likewise it is critical that the portion of the burner devoted to burning gas fuel be perfectly in order even when the burner is burning oil fuel. Unfortunately, it is often the case that the oil section of the burner does not work properly during periods of time when the burner is burning gas fuel. The reason for this is the structure of standard combination oil and gas burners.

The standard combination oil and gas burner has an oil pump that is driven by the same motor, the fan motor, that drives the fan in the burner. Since the fan itself has to be on both when oil fuel is being burned and when gas fuel is being burned, i.e. at all times, the fan motor must also be on at all times. The oil pump is connected by a shaft to the fan motor and consequently the oil pump is necessarily also on all the time. As a result, oil circulates through the oil passage tubes at all times—both when the burner is burning oil and when the burner is burning gas. Although when the burner is burning gas oil fuel still circulates, the oil fuel does not actually enter the burner to be burned. When gas is being burned in the burner, the oil fuel is blocked from entry to the burner by a solenoid valve. However, the oil fuel still constantly circulates through the oil passages tubes even during gas mode. This phenomenon causes problems.

With oil fuel constantly circulating through the oil passages when the burner is burning gas fuel, the oil filters in the oil passage tubes tend to become clogged with debris from the oil since no one is monitoring the oil filters. This in turn means that at some point oil fuel stops circulating although the oil pump continues spinning. When this happens, the gears in the oil pump begin to wear down since a secondary function of the oil fuel is to lubricate the oil pump gears. Typically, however, no one notices the problems developing on the oil side because the focus is on maintaining the proper operation of the gas side of the burner during the period that the burner is in burning gas fuel. As a result, the oil pump becomes completely nonfunctional and has to be replaced. If the oil pump is nonfunctional at a time when the building owner gets a sudden notice to switch to burning oil fuel, the building owner has a problem—he cannot switch and may be forced to pay a severe fine. This is a constant problem.

One possible solution to this problem is to for the building owner to purchase the combination oil and gas burner with a separate pump set, which involves installing a separate motor that drives a separately mounted oil pump on the floor of the boiler room adjacent the burner. This option has drawbacks. The cost of a separate pump set is approximately $3,000. Moreover, general contractors will usually not advise the building owner of this option because they know that if this is presented to the owner it gets tacked on to the overall price and renders the owner skeptical about the overall price of installing the combination oil and gas burner (“I have a contractor who can do it for less”). The fact that the general contractor can explain that the extra cost is because of the separate pump set does not alter the psychological effect of quoting a higher price. Hence, the separate pump set is almost never included with the purchase of a combination oil and gas burner. What is needed is an alternative solution to this problem of the breakdown of the oil pump that does not increase the overall cost of the combination oil and gas burner and does not require extra labor from extra monitoring and is consistent with human psychology. The present invention addresses the above problem, solves it and offers additional features.

### SUMMARY OF THE PRESENT INVENTION

In accordance with the present invention, a magnetic clutch assembly for a hybrid oil and gas burner is presented in which the magnetic clutch assembly is inserted between the fan motor and the oil pump of the combination oil and gas burner in order to selectively operate the oil pump and thereby prevent any oil fuel from circulating during gas mode. When the burner is switched into oil mode the magnetic clutch assembly engages the oil pump. When the burner is switched into gas mode the magnetic clutch assembly disengages the oil pump so that the fan motor no longer drives the oil pump and oil fuel does not circulate and potentially clog the oil filter. A hybrid oil and gas burner incorporating such a magnetic clutch assembly is also disclosed.

### OBJECTS AND ADVANTAGES

The following are the important objects and advantages of the present invention:

(a) to provide a magnetic clutch assembly fitted between an oil pump and a fan motor in a hybrid oil and gas burner so that the magnetic clutch assembly selectively operates the oil pump,

(b) to provide a magnetic clutch assembly that prevents breakdown of the oil pump that would arise from clogging of the oil filter if in gas mode oil fuel would continue to circulate,

(c) to provide a magnetic clutch assembly in a hybrid oil and gas burner that performs a safety function in that the magnetic clutch reduces the risk of fire by acting as a barrier that prevent oils from entering the fan housing in the event of a failure of the seal of the oil pump shaft,

(d) to provide a magnetic clutch assembly comprising a magnetic clutch having an electromagnet and a magnetic clutch shaft, an and outer inner clutch plate and a magnetic clutch housing for securely placing the magnetic clutch assembly between the oil pump and the fan motor,

(e) to provide a combination oil and gas burner that does not pump oil unless it is desired that oil be used for fuel, i.e. in the oil mode,

(f) to provide a combination oil and gas burner in which there is no constant danger of the oil pump breaking down,

(g) to provide a combination oil and gas burner that selectively operates the oil pump by means of a magnetic clutch assembly, and

(h) to provide a combination oil and gas burner that directs the magnetic clutch assembly to engage the oil pump when the switch turns on the oil mode and directs the magnetic clutch to disengage the oil pump when the switch turns on the gas mode from the oil mode.

### BRIEF DESCRIPTION OF THE DRAWINGS

FIG. 1 is an exploded view of the magnetic clutch assembly of the present invention.

FIG. 2 is a sectional view of the magnetic clutch assembly of the present invention.

FIG. 3 is an exploded view of certain parts of the oil and gas burner of the present invention running from the oil pump to the fan motor which view includes the magnetic clutch assembly of the present invention in a general schematic form.

FIG. 4A is a schematic of certain elements of the oil and gas burner of the present invention.

FIG. 4B is a schematic of the electrical power lines controlled of the switch in the burner of the present invention.

### DETAILED DESCRIPTION OF THE PREFERRED EMBODIMENT

The apparatus will now be illustrated by reference to the accompanying drawings. The combination oil and gas burner of the present invention has been assigned reference numeral 10 and the magnetic clutch assembly has been assigned reference numeral 90. Other elements have been assigned the reference numerals referred to below. The term “burner element” as used herein refers to the furnace or burner compartment where the oil or gas fuel is actually burned. In contrast, the terms “burner” or “oil and gas burner” refer to the overall device, one part of which is the burner element or furnace.

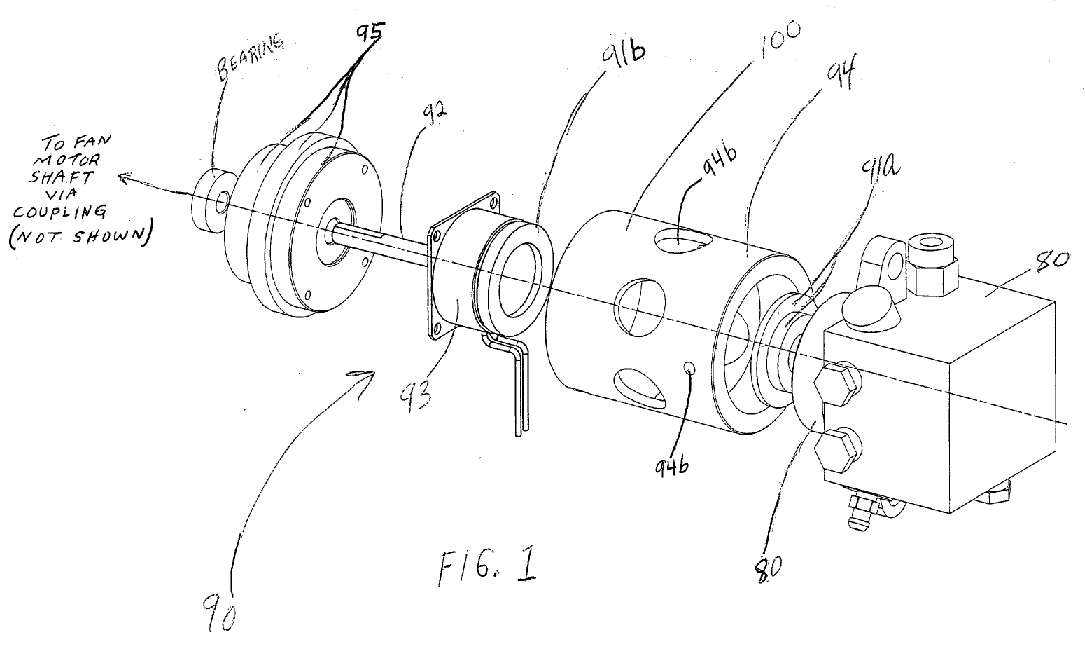

As seen from FIGS. 1-4, a magnetic clutch assembly 90 is fitted into a combination oil and gas burner 10 that alternatively burns oil and gas. Oil and gas burner 10 operates with gas fuel, oil fuel and also includes a burner element 30. The oil and gas burner element 30 is alternatively used for burning oil and for burning gas fuel. Burner element 30, and hence burner 10, are each capable of functioning in an oil mode and capable of functioning in a gas mode.

Typically, during a first series of time periods oil and gas burner 10 functions in an “oil mode” wherein its burner element 30 burns oil fuel 40 inside the burner element 30. During a second series of time periods oil and gas burner 10 functions in “gas mode” wherein the burner element 30 burns gas fuel 50 inside the burner element 30. The user simply turns switch 60 to change from one mode to the other. Switch 60 determines whether the oil and gas burner 10 functions in the oil mode or in the gas mode.

Burner element 30 is for burning oil fuel during oil mode and for burning gas fuel during gas mode. Burner 10 also includes the standard components such as oil fuel conduits 89 for transmitting oil fuel from the oil pump 80 to the burner element 30 and the standard oil passage tubes 88 that circulate oil fuel from an oil tank 87 or other oil fuel source to the oil pump 80 and back through a return oil passage tube 88a from the oil pump 80 to the oil fuel tank 86 during oil mode, and standard gas fuel conduits 98 and other components for transmitting gas fuel to the burner element 30 from a gas fuel source during gas mode.

Fan 70 and fan motor 72 are standard equipment in the oil and gas burner 10. Fan motor 72 drives fan 70 both in the oil mode and in the gas mode. Oil pump 80 is driven by the fan motor 72. Oil pump 80 causes oil fuel 40 to circulate through an oil passage tube 88 and a return oil passage tube 88a between the oil pump and the oil fuel tank 86. Oil pump 80 also pumps oil fuel 40 through oil fuel conduit 89 running from oil pump 80 past valve 90 to a gun assembly 31 inside the burner element 30. Oil passage tube 88 forms part of the oil fuel conduits. The gun assembly 31 sprays oil fuel 40 in the burner 30 to burn the oil fuel 40. The oil passage tube 88 is controlled by a valve 90. In gas mode, valve 90, which typically is a solenoid valve, is a back-up feature that would block the passage of oil fuel 40 into the gun assembly 31. Such oil fuel 40 would not, however, flow since oil pump 80 is disengaged by magnetic clutch assembly 90 during gas mode.

Oil passage tubes 88 also have one or more oil filters 87 at strategic locations thereof for the purpose of filtering and purifying oil fuel 40 before the oil fuel 40 enters burner element 30. These oil filters 87 need to be replaced after they become clogged following a certain amount of usage.

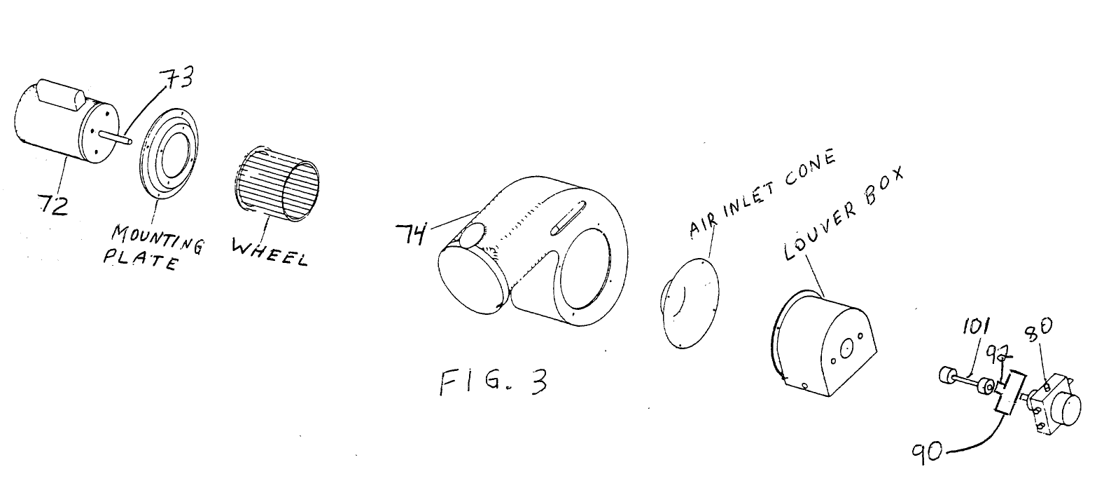

As seen from FIG. 1 through FIGS. 4A-B, magnetic clutch assembly 90 is fitted between oil pump 80 and fan motor 72. In order to fit magnetic clutch assembly 90 onto the oil pump shaft 82 of oil pump 80, a substantially cylindrical hole is bored into the inner clutch plate 91a of the magnetic clutch assembly 90 consistent with the diameter of oil pump shaft 82 of oil pump 80. Then magnetic clutch assembly 90 is inserted onto oil pump shaft 82 of oil pump 80 so that magnetic clutch assembly 90 can be positioned between oil pump 80 and fan motor 72. As best seen from FIG. 3, the magnetic clutch shaft 92 is also connected to the fan motor shaft 73 by means of a coupling 101 inserted between the magnetic clutch shaft 92 and the fan motor shaft 73. It should be noted that magnetic clutch assembly 90 and magnetic clutch shaft 92 are presented only in a general schematic form within the exploded view of certain parts of the burner 10 shown in FIG. 3 and this is done simply to illustrate the placement of the magnetic clutch assembly 90 between oil pump 80 and fan motor 72 via coupling 101. Without the magnetic clutch assembly 90 present, fan motor 72 would be coupled to and would drive the oil pump 80. With the presence of magnetic clutch assembly 90 in between oil pump 80 and fan motor 72, magnetic clutch assembly 90 regulates whether fan motor 72 drives oil pump 80 because magnetic clutch assembly 90 selectively engages oil pump 80.

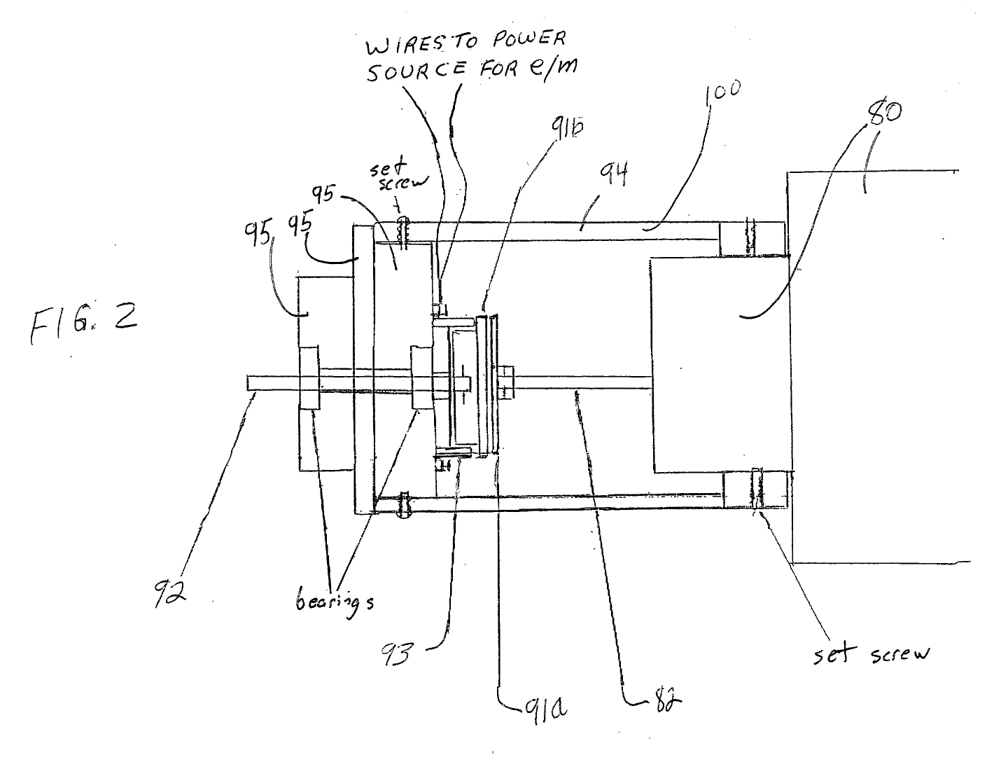

Magnetic clutch assembly 90 comprises magnetic clutch 93 having an electromagnet and wiring. Magnetic clutch 93 has attached to it magnetic clutch shaft 92. Magnetic clutch assembly 90 also includes magnetic clutch housing 100 to protect and securely position magnetic clutch 93 between oil pump 80 and fan motor 72. Preferably magnetic clutch housing 100 is comprised of a magnetic clutch cover 94 which is preferably perforated with transverse holes 94a to provide air circulation for the electromagnet inside magnetic clutch 93 and at least one transverse hole 94b to allow easy installation and position adjustment of the magnetic clutch 93 in the magnetic clutch assembly 90. Clutch cover 94 is hollow and preferably substantially cylindrical as seen in FIG. 1. Magnetic clutch housing 100 also includes a clutch cover end plate 95 and bearings. Typically there are two bearings. Magnetic clutch assembly 90 also includes an inner magnetic clutch plate 91a and an outer magnetic clutch plate 91b. As best seen in FIGS. 1-2, clutch cover end plate 95 contains two bearings and couples to fan motor shaft 73 of fan motor 72. Inner magnetic clutch plate 91a fits onto oil pump shaft 82 of oil pump 80.

Magnetic clutch assembly 90 thereby controls activation of the oil pump 80 so that in oil mode, when the burner element 30 is supposed to be burning oil fuel 40, magnetic clutch assembly 90 automatically engages the oil pump 80. When oil pump 80 is engaged by magnetic clutch assembly 90, the power of the fan motor 72 drives the oil pump 80 whereupon oil fuel 40 is pumped out of oil pump 80 and circulates through oil passage 88 and into burner element 30 where it is sprayed by the gun assembly 31 and burned by burner element 30. Conversely, when it is desired to burn gas, i.e. in gas mode, magnetic clutch assembly 90 disengages oil pump 80 so that oil pump 80 is not receiving a turning force from fan motor 72 and hence oil pump 80 is not spinning or pumping oil fuel 40. Since no oil fuel 40 is being pumped out of oil pump 80, no oil fuel is circulating in oil passage 88. Hence in gas mode oil fuel 40 will not clog oil filters in oil passage 88, something that would happen without magnetic clutch assembly 90 in place, as explained, leading to the breakage of oil pump 80.

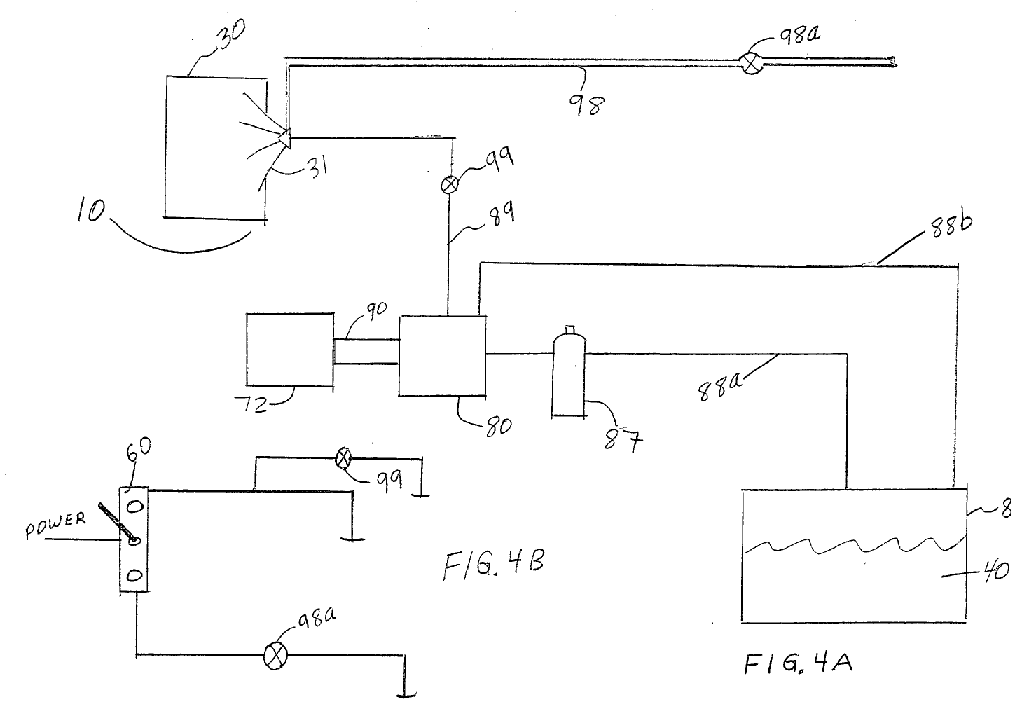

FIG. 4A is a schematic that depicts some of the basic elements of the hybrid oil and gas burner of the present invention.

The present invention is the magnetic clutch assembly 90 itself as well as the combination oil and gas burner 10 that incorporates the magnetic clutch assembly 30.

The burner of the present invention is a safe and durable burner that alternatively functions in an oil mode during which the burner burns oil fuel and in a gas mode during which the burner burns gas fuel. The burner 10 includes burner element 30 for burning oil fuel during the oil mode and for burning gas fuel during the gas mode, an oil fuel tank 86 for storing oil fuel, an oil fuel passage tube 88 for circulating oil fuel from the oil fuel tank 86 to the oil pump 80 during oil mode and a return oil passage tube 88a for circulating oil fuel from the oil pump 80 back to the oil fuel tank 86 during oil mode, the oil passage tube 88 traversing at least one oil filter 87, a gas fuel conduit 98 for transmitting gas fuel to the burner element 30 from a gas fuel source during gas mode, the gas fuel conduit 98 controlled by a gas valve 98a, a switch 60 having a first setting that places the burner 10 in the oil mode and having a second setting that places the burner 10 in the gas mode, a fan and a fan motor 72, the fan motor 72 driving the fan both in the oil mode and in the gas mode, an oil pump 80 driven by the fan motor, the oil pump 80 pumping oil fuel during oil mode to the burner element through an oil fuel conduit 89 so the oil fuel can be burned, the oil fuel conduit 89 controlled by an oil valve 99 that in gas mode blocks passage of any oil fuel, and a magnetic clutch assembly 90 fitted between the oil pump 80 and the fan motor, where the magnetic clutch assembly 90 controls activation of the oil pump 80 whereby in oil mode the magnetic clutch assembly 90 automatically engages the oil pump 80 whereupon the fan motor 72 drives the oil pump 80 and oil fuel circulates through the oil passage tube 88 and the return oil passage tube 88a and is transmitted to the burner element 30 and whereby in gas mode the magnetic clutch assembly 90 disengages the oil pump 80 so that oil fuel cannot circulate through the oil passage tube 88, the return oil passage tube 88a or the oil fuel conduit 89.

The magnetic clutch assembly 90 ensures that in gas mode oil fuel cannot circulate in and clog the oil passage 88 and that either gas mode or in oil mode oil fuel cannot leak into the fan motor 72 and catch fire in the burner element if a seal of oil pump shaft 82 fails.

By having magnetic clutch between the oil pump 80 and the fan motor 72 another advantage gleaned is safety. The risk of fire is lessened. The magnetic clutch 92 between the oil pump 80 and the fan motor 72 acts as a barrier that prevent oil from entering the fan housing 74 in the event of a failure of the seal of the oil pump shaft 82. Normally the seal of the oil pump shaft 82 is inside the fan housing 74. If the seal of the oil pump shaft 82 fails, the oil fuel leaks and enters the fan housing and the fan causes the oil fuel to be thrown around everywhere in the burner. This causes a fire because the oil fuel is flammable. With the presence of the magnetic clutch assembly 90 between the oil pump 80 and fan motor 72, the seal of oil pump shaft 82 is outside the fan housing 74 so that even if the seal fails, no oil enters the fan motor 72 where it could be in danger of catching fire in the burner element 30.

It is to be understood that while the method and composition of this invention have been described and illustrated in detail, the above-described embodiments are simply illustrative of the principles of the invention. It is to be understood also that various other modifications and changes may be devised by those skilled in the art which will embody the principles of the invention and fall within the spirit and scope thereof It is not desired to limit the invention to the exact construction and operation shown and described. The spirit and scope of this invention are limited only by the spirit and scope of the following claims.

What is claimed is:

1. A magnetic clutch assembly for use in a hybrid oil and gas burner, the burner functioning alternately in an oil mode to burn oil fuel inside a burner element and alternately in a gas mode to burn gas fuel inside the burner element and the burner including a fan motor that drives a fan and an oil pump, the magnetic clutch assembly comprising:
a magnetic clutch including an electromagnet and including a magnetic clutch shaft, the magnetic clutch shaft for coupling the magnetic clutch assembly to a shaft of the fan motor,
an inner clutch plate that fits on a shaft of the oil pump,
an outer clutch plate,
a magnetic clutch housing for securely placing the magnetic clutch assembly between the oil pump and the fan motor,
wherein the magnetic clutch assembly controls activitation of the oil pump in that when the burner is switched into oil mode the magnetic clutch assembly automatically engages the oil pump whereupon the fan motor drives the oil pump and oil fuel circulates in the oil passage tubes and is pumped to the burner element and when the burner is switched into gas mode the magnetic clutch assembly disengages the oil pump and the oil pump does not circulate oil fuel in the oil passage tubes and does not pump any oil fuel to the burner element.

2. The magnetic clutch assembly of claim 1, wherein the magnetic housing comprises a clutch clover and a clutch cover end plate that includes bearings.

3. The magnetic clutch assembly of claim 2, wherein the clutch cover is hollow and substantially cylindrical and has transverse holes in order to provide air circulation for the electromagnet and has at least one transverse hole for installation and position adjustment of the magnetic clutch in the magnetic clutch assembly.

4. The magnetic clutch assembly of claim 1, wherein the magnetic clutch shaft connects to the shaft of the fan motor by means of a coupling.

5. The magnetic clutch assembly of claim 1, wherein the magnetic housing comprises a clutch clover and a clutch cover end plate that includes bearings and wherein the magnetic clutch shaft connects to the shaft of the fan motor by means of a coupling.

6. The magnetic clutch assembly of claim 1, wherein the magnetic housing comprises a clutch clover and a clutch cover end plate that includes bearings, wherein the clutch cover is hollow and substantially cylindrical and has transverse holes in order to provide air circulation for the electromagnet and has at least one transverse hole for installation and position adjustment of the magnetic clutch in the magnetic clutch assembly and wherein the magnetic clutch shaft connects to the shaft of the fan motor by means of a coupling.

7 A safe and durable burner that alternatively functions in an oil mode during which the burner burns oil fuel and in a gas mode during which the burner burns gas fuel, the burner comprising:
a burner element for burning oil fuel during the oil mode and for burning gas fuel during the gas mode,
an oil fuel tank for storing oil fuel,
an oil fuel passage tube for circulating oil fuel from the oil fuel tank to the oil pump during oil mode and a return oil passage tube for circulating oil fuel from the oil pump back to the oil fuel tank during oil mode, the oil passage tube traversing at least one oil filter,
a gas fuel conduit for transmitting gas fuel to the burner element from a gas fuel source during gas mode, the gas fuel conduit controlled by a gas valve
a switch having a first setting that places the burner in the oil mode and having a second setting that places the burner in the gas mode,
a fan and a fan motor, the fan motor driving the fan both in the oil mode and in the gas mode,
an oil pump driven by the fan motor, the oil pump pumping oil fuel during oil mode to the burner element through an oil fuel conduit so the oil fuel can be burned, said oil fuel conduit controlled by an oil valve that in gas mode blocks passage of any oil fuel,
a magnetic clutch assembly fitted between the oil pump and the fan motor,
the magnetic clutch assembly controlling activation of the oil pump whereby in oil mode the magnetic clutch assembly automatically engages the oil pump whereupon the fan motor drives the oil pump and oil fuel circulates through the oil passage tube and the return oil passage tube and is transmitted to the burner element and whereby in gas mode the magnetic clutch assembly disengages the oil pump so that oil fuel cannot circulate through the oil passage tube, the return oil passage tube or the oil fuel conduit,
the presence of the magnetic clutch assembly preventing breakdown of the oil pump during gas mode and preventing fire arising from leaking of oil fuel into the fan motor if an oil pump shaft fails.

8. The burner of claim 7, wherein the magnetic clutch assembly comprises
a magnetic clutch including an electromagnet and including a magnetic clutch shaft, the magnetic clutch shaft for coupling the magnetic clutch assembly to a shaft of the fan motor,
an inner clutch plate that fits on a shaft of the oil pump,
an outer clutch plate, and
a magnetic clutch housing for securely placing the magnetic clutch assembly between the oil pump and the fan motor.

9. The burner of claim 8, wherein the magnetic housing comprises a clutch clover and a clutch cover end plate that includes bearings.

10. The burner of claim 9, wherein the clutch cover is hollow and substantially cylindrical and has transverse holes in order to provide air circulation for the electromagnet and has at least one transverse hole for installation and position adjustment of the magnetic clutch in the magnetic clutch assembly.

11. The burner of claim 8, wherein the magnetic clutch shaft connects to the shaft of the fan motor by means of a coupling.

12. The burner of claim 8, wherein the magnetic housing comprises a clutch clover and a clutch cover end plate that includes bearings and wherein the magnetic clutch shaft connects to the shaft of the fan motor by means of a coupling.

13. The burner of claim 8, wherein the magnetic housing comprises a clutch clover and a clutch cover end plate that includes bearings, wherein the clutch cover is hollow and substantially cylindrical and has transverse holes in order to provide air circulation for the electromagnet and has at least one transverse hole for installation and position adjustment of the magnetic clutch in the magnetic clutch assembly and wherein the magnetic clutch shaft connects to the shaft of the fan motor by means of a coupling.
